(19) United States
(12) Patent Application Publication
(10) Pub. No.: US 2014/0190774 A1
(43) Pub. Date: Jul. 10, 2014

(54) CIRCULATION TRANSPORT SYSTEM

(71) Applicants: Arthur C. Hsu, South Glastonbury, CT (US); Andrzej Ernest Kuczek, Bristol, CT (US)

(72) Inventors: Arthur C. Hsu, South Glastonbury, CT (US); Andrzej Ernest Kuczek, Bristol, CT (US)

(73) Assignee: OTIS ELEVATOR COMPANY, Farmington, CT (US)

(21) Appl. No.: 14/116,209

(22) PCT Filed: May 11, 2011
(86) PCT No.: PCT/US2011/036020

§ 371 Date: Feb. 12, 2014

(51) Int. Cl. B66B 11/00

(52) U.S. Cl. CPC B66B 11/0005
USPC 187/406

(57) ABSTRACT

An elevator system includes two or more hoistways. One or more elevator cars are located in a first of the two or more hoistways and movable to a second hoistway of the two or more hoistways. The system further includes one or more elevator car transfer mechanisms including a transfer cage receptive of an elevator car of the one or more elevator cars and one or more transfer rails extending from the first hoistway to the second hoistway. The transfer cage is connected to the one or more transfer rails and is configured to transfer the elevator car received in the transfer cage by movement of the transfer cage along the one or more transfer rails from the first hoistway to the second hoistway.

### BACKGROUND

The subject matter disclosed herein relates to elevator systems. More specifically, the subject disclosure relates to circulation elevator systems.

In especially tall structures and/or ones where there is a high volume of passenger traffic, a variety of elevator system solutions are utilized in order to reduce space used by the elevator systems to service the structure and/or increase a flow rate of elevators cars and passengers throughout the system. In some systems, a first elevator car serving lower floors of a structure travels up a hoistway and stops, where it aligns with a second elevator car in an adjacent hoistway which serves upper floors of the structure. To reach the upper floors, passengers transfer from the first car to the second car, by walking between the side-by-side cars, then the second car proceeds up the adjacent hoistway.

In other systems, adjacent hoistways are utilized, with the elevator cars traveling along the hoistways in a car frame structure. A first car frame services the lower floors of the structure in a first hoistway, and a second car frame services the upper floors of the structure in a second, adjacent hoistway. To reach the upper floors of the structure, the elevator car is transferred between the first car frame and the second car frame and proceeds up the second hoistway. In such a system, however, while the car is transferring between car frames it is not secured to the guide rails of either hoistway. Further, the need to re-connect to the guide rails upon the transfer raises concerns about reliability.

### SUMMARY

An embodiment of an elevator system includes two or more hoistways. One or more elevator cars are located in a first of the two or more hoistways and movable to a second hoistway of the two or more hoistways. The system further includes one or more elevator car transfer mechanisms including a transfer cage receptive of an elevator car of the one or more elevator cars and one or more transfer rails extending from the first hoistway to the second hoistway. The transfer cage is connected to the one or more transfer rails and is configured to transfer the elevator car received in the transfer cage by movement of the transfer cage along the one or more transfer rails from the first hoistway to the second hoistway.

In another embodiment, the elevator system additionally or alternatively includes one or more rollers connecting the transfer cage to the one or more transfer rails.

In another embodiment, the transfer cage additionally or alternatively includes one or more cage rails substantially alignable with one or more elevator car guides located in the first hoistway to guide the one or more elevator cars into the transfer cage.

In another embodiment, the elevator system additionally or alternatively includes a locking mechanism located at the elevator car engagable with the one or more cage rails to hold the one or more elevator cars in the transfer cage.

In another embodiment, the transfer cage is additionally or alternatively receptive of two or more elevator cars.

In another embodiment, the one or more elevator car transfer mechanisms are additionally or alternatively located in at least one of a top or bottom of the two or more hoistways.

In another embodiment, the elevator system additionally or alternatively includes one or more intermediate elevator car transfer mechanisms disposed between a top and a bottom of the two or more elevator hoistways.

In another embodiment, an elevator car transfer apparatus includes a transfer cage receptive of at least one elevator car; and one or more transfer rails extending from a first elevator system hoistway to a second elevator system hoistway and operably connected to the transfer cage. The transfer of the at least one elevator car received in the transfer cage is achieved by movement of the transfer cage along the one or more transfer rails from the first elevator system hoistway to the second elevator system hoistway.

An embodiment of a method of operating an elevator system includes moving one or more elevator cars substantially vertically in a first direction along a first hoistway and moving an elevator car of the one or more elevator cars into a transfer cage substantially aligned with the first hoistway. The elevator car and transfer cage are translated substantially horizontally along a transfer rail extending from the first hoistway to a second hoistway. The elevator car is moved substantially vertically in a second direction along the second hoistway.

In another embodiment, moving the elevator car into a transfer cage substantially aligned with the first hoistway additionally or alternatively includes moving the elevator car along one or more elevator car guides located in the first hoistway and moving the elevator car from the one or more elevator car guides to one or more transfer rails of the transfer cage. The one or more transfer rails are substantially aligned with the one or more elevator car guides.

In another embodiment, the method additionally or alternatively includes holding the elevator car in the transfer cage via application of a locking mechanism to the one or more transfer rails.

In another embodiment, the method additionally or alternatively includes the first direction being substantially opposite the second direction.

In another embodiment, an elevator system additionally or alternatively includes at least three hoistways and a plurality of elevator cars disposed in the at least three hoistways. The elevator system further includes an elevator car transfer mechanism including a transfer cage receptive of an elevator car of the plurality of elevator cars and one or more transfer rails extending from a first hoistway of the at least three hoistways to a second hoistway of the at least three hoistways. The transfer cage is connected to the one or more transfer rails and is configured to transfer an elevator car of the plurality of elevator cars received in the transfer cage by movement of the transfer cage along the one or more transfer rails from the first hoistway to the second hoistway. A direction of elevator car travel in one or more hoistways of the at least three hoistways is in a first direction and the direction of elevator car travel in one or more hoistways of the at least three hoistways is in a second direction.

In another embodiment, an elevator system additionally or alternatively includes the first direction being substantially opposite the second direction.

In another embodiment, an elevator system additionally or alternatively includes the elevator cars in one or more outer hoistways traveling in the first direction, and elevator cars in one or more inner hoistways traveling in the second direction.

In another embodiment, an elevator system additionally or alternatively includes a direction of travel of elevator cars in the at least three hoistways which is reversible.

In another embodiment, the elevator system additionally or alternatively includes two or more hoistways and one or more independently-controlled elevator cars disposed in the two or more hoistways. Two or more lateral transfer mechanisms move an elevator car of the one or more elevator cars from a first hoistway of the two or more hoistways to a second hoistway of the two or more hoistways. A direction of travel of elevator cars in a hoistway of the two or more hoistways is uniform among all elevator cars in the hoistway.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic view of an embodiment of an elevator system;

FIG. 2 is a schematic view of an embodiment of a transfer mechanism for an elevator system;

FIGS. 3a-3e schematically illustrate transfer of an elevator car from a first hoistway to a second hoistway;

FIG. 4 schematically illustrates traffic flow of elevator cars in an elevator system;

FIG. 5 schematically illustrates another embodiment of traffic flow of elevator cars in an elevator system; and

FIG. 6 illustrates another embodiment of a transfer mechanism for an elevator system.

The detailed description explains embodiments of the invention, together with advantages and features, by way of example with reference to the drawings.

### DETAILED DESCRIPTION

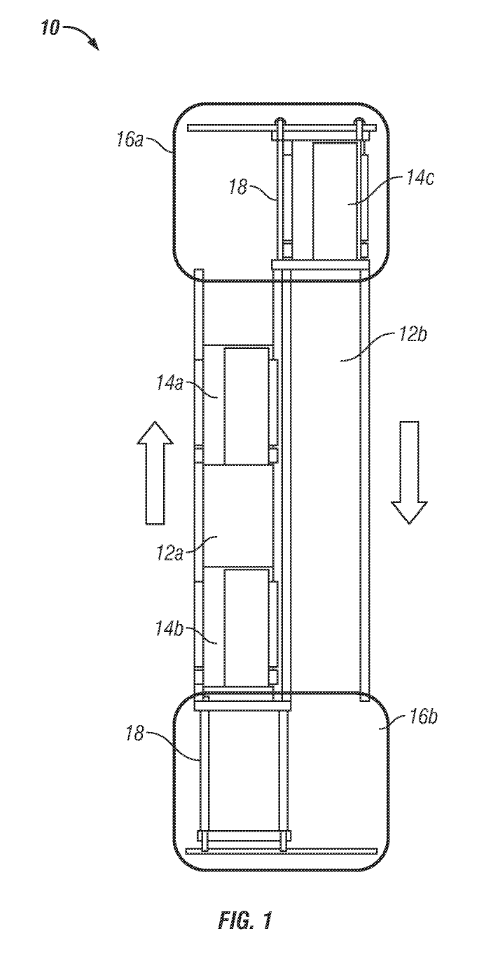

Shown in FIG. 1 is an embodiment of an elevator circulation system 10. The system 10 of this embodiment includes two hoistways 12, a first hoistway 12a configured for upward travel of a plurality of elevator cars 14, and a second hoistway 12b configured for downward travel of the plurality of elevator cars 14, which in this embodiment are self-propelled elevator cars 14 having self-contained, independent drive systems. In some embodiments, more than one elevator car 14 is disposed in each hoistway 12, thereby allowing for increased passenger traffic in the system 10. A lateral transfer area 16 is located at each end of the hoistways 12. A top lateral transfer area 16a is located at a top of the hoistways 12 and a bottom lateral transfer area 16b is located at a bottom of the hoistways 12. In the lateral transfer areas 16, the transfer elevator cars 14 are transferred from one hoistway 12 to another hoistway 12 so its direction of travel can be reversed from upward to downward or vice-versa, so the plurality of elevator cars 14 travel in a circulation pattern. For example, as shown in FIG. 1, in this embodiment there are three elevator cars 14a, 14b and 14c. Three elevator cars 14 are shown, but it is to be appreciated that that quantity is merely exemplary and any selected number of elevator cars 14 may be utilized. Elevator car 14a is proceeding upward in hoistway 12a followed by elevator car 14b, and elevator car 14c, having been transferred to hoistway 12b via the top lateral transfer area 16a is positioned to proceed downward, as will elevator cars 14a and 14b once each reaches the top lateral transfer area 16a. Once elevator car 14c reaches the bottom lateral transfer area 16b, elevator car 14c will be transferred to hoistway 12a and proceed upwardly, followed by elevator cars 14a and 14b. In this embodiment, all of the elevator cars 14 will proceed around the system 10 in a clockwise direction with elevator car 14a always following elevator car 14c, elevator car 14b always following elevator car 14a and elevator car 14c always following elevator car 14b. The movements of the elevator cars 14a, 14b and 14c are completely independent of each other, except that no elevator car 14 can overtake another elevator car 14.

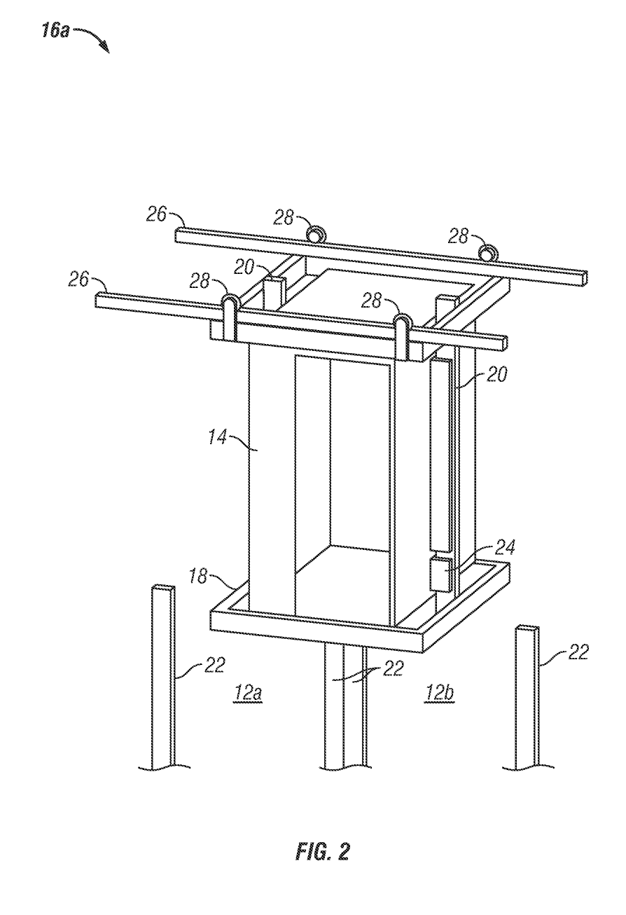

Referring now to FIG. 2, the top lateral transfer area 16a is illustrated. While the top lateral transfer area 16a is illustrated in FIG. 2, it is to be appreciated that the structure of the bottom lateral transfer area 16b is substantially the same as that of the top lateral transfer area 16a, except for its position along the hoistway 12. The transfer area 16a includes a transfer cage 18, which is laterally movable to transfer the elevator car 14 from the first hoistway 12a to the second hoistway 12b. The transfer cage 18 may be, for example, an array of structural beams, a space frame, or a membrane with appropriate stiffeners. The transfer cage 18 includes two vertical cage rails 20, which are dimensionally similar to hoistway rails 22 used to guide the elevator car 14 vertically through the hoistway 12. Even though the use of hoistway rails 22 to guide the elevator car 14 is discussed herein, it is to be appreciated that the use of hoistway rails 22 is merely exemplary and other means of guiding the elevator car 14 may be utilized. For example, the elevator car 14 may be guided by a set of guidance wheels (not shown) along the hoistway 12. The cage rails 20 are configured such that when aligned with the hoistway rails 22, the elevator car 14 can move smoothly between the hoistway rails 22 and the cage rails 20. When the elevator car 14 moves to the cage rails 20 and into the transfer cage 18, a rail brake 24 or other locking mechanism engages the cage rails 20 to hold the elevator car 14 in position in the transfer cage 18. This rail brake 24 may be a separate component, or may be a part of the drive system of the elevator car 14. The transfer area 16a further includes one or more transfer rails 26, which in some embodiments are two transfer rails 26, which are substantially horizontal. The transfer cage 18 is movably attached to the transfer rails 26, for example, by one or more rollers 28, allowing the transfer cage 18 to move from alignment with the first hoistway 12a to alignment with the second hoistway 12b, and from alignment with the second hoistway 12b to alignment with the first hoistway 12a within the transfer area 16a. The transfer cage 18 is driven by, for example, a machine (not shown) attached to the transfer cage 18, or alternatively may be cable-driven along the transfer rails 26.

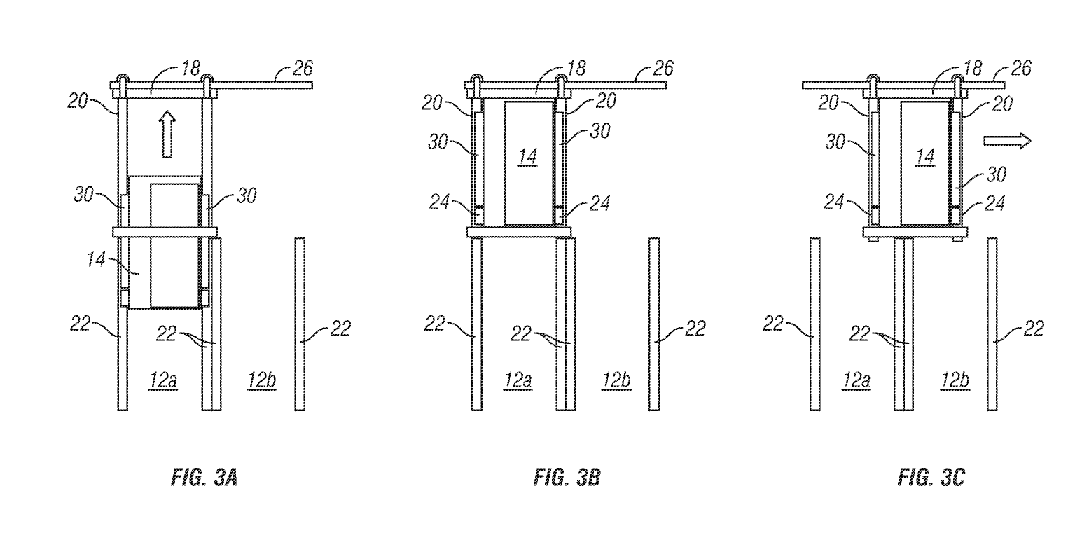

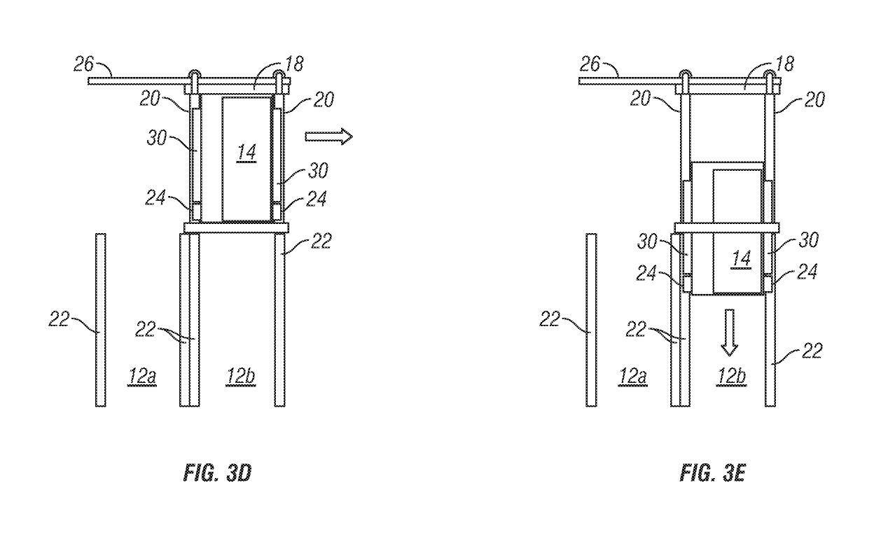

FIGS. 3a-3e illustrate the transfer of an elevator car 14 from a first hoistway 12a to a second hoistway 12b via the top lateral transfer area 16a. It is to be appreciated that substantially the same process occurs transferring the elevator car 14 from the second hoistway 12b to the first hoistway 12a. Beginning with FIG. 3a, the elevator car 14 proceeds upwardly along the first hoistway 12a and enters the transfer cage 18, such that cage guides 30 move from the hoistway rails 22 to the cage rails 20, and the elevator car 14 is fully within the transfer cage 18 in the position shown in FIG. 3b, and the rail brake 24 is engaged to prevent vertical movement of the elevator car 14. As shown in FIG. 3c, the transfer cage translates substantially horizontally along the transfer rails 26 toward the second hoistway 12b until the cage rails 20 are aligned with the hoistway rails 22 of the second hoistway 12b as shown in FIG. 3d. Referring now to FIG. 3e, the rail brake 24 is disengaged, allowing the elevator car 14 to move vertically downward from the transfer cage 18 into the second hoistway 12b.

While the transfer area 16a and 16b are shown as located substantially at the top and bottom of the hoistways 12a and 12b, it is to be appreciated that those locations are merely exemplary. Transfer areas 16 may be located at any desired location along the hoistways 12, in addition to or in place of the transfer areas 16a and 16b defining an elevator system with the desired transfer locations and circulation patterns. For example, there may be one or more intermediate transfer areas 16 located along the length of the hoistway 12 between transfer areas 16a and 16b. The intermediate transfer areas 16 may be utilized to, for example, move an elevator car 14 to another hoistway 12 before reaching the top or bottom of the hoistway 12, or to temporarily remove an elevator car 14 from the hoistway 12 to allow another elevator car 14 to pass.

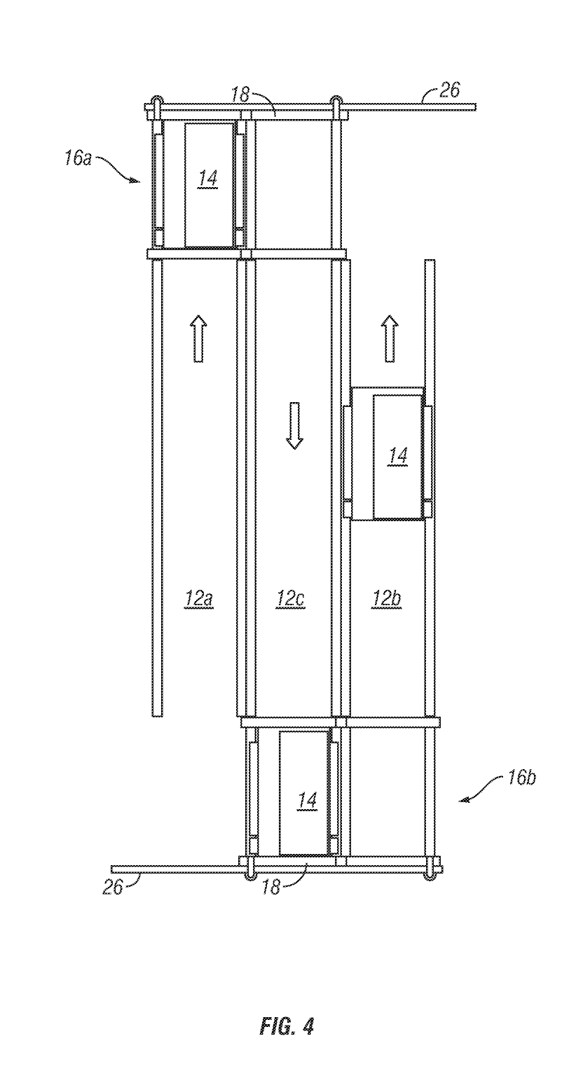

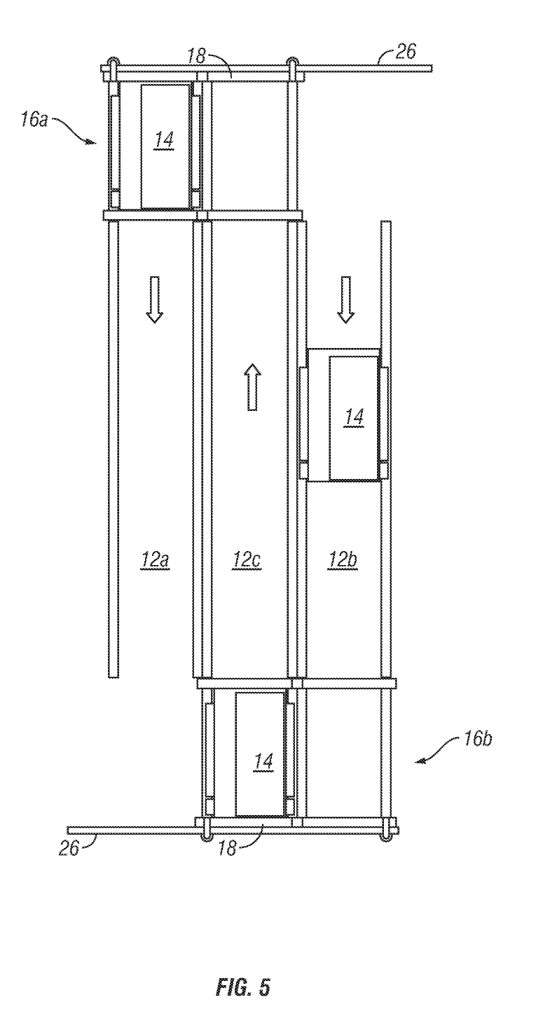

An example of an alternative system utilizing three hoistways 12 is shown in FIG. 4. This configuration is advantageous, especially in situations where the peak traffic in the building has a predominant direction. For example, in an office building the traffic is predominantly upward between, for example 8 am and 9 am, while the traffic is predominantly downward between, for instance, 5 pm and 6 pm. In the three hoistway configuration shown in FIG. 4, the outer hoistways 12a and 12b are utilized to carry traffic upward, while the inner hoistway 12c is utilized to carry traffic downward. The elevator cars 14 transfer between the outer hoistways 12a, 12b and the inner hoistway 12c at the transfer areas 16a and 16b. During down-peak traffic situations, or ones where the predominant traffic flow direction is downward, the directions of travel in the three hoistways 12 can be reversed as shown in FIG. 5. In FIG. 5, the outer hoistways 12a and 12b are dedicated to downward travel of the elevator cars 14, while the inner hoistway 12c is dedicated to upward travel of the elevator cars 14. During non-peak operational times, one of the hoistways 12 may be shut down, so that the third hoistway 12 is only used during peak travel times. Further, during periods of very light traffic, it may be desired to utilize only a single hoistway 12. During these non peak times, elevator cars 14 may be temporarily removed from service by transferring them to one of the unused hoistways 12. Further, in other embodiments, the transfer cages 18 may be utilized to remove elevator cars 14 from the system 10 temporarily to a parking area outside the hoistways for, for example, maintenance or replacement. As such, maintenance may be performed on elevator cars 14 without taking a hoistway 12 or the entire system 10 out of service.

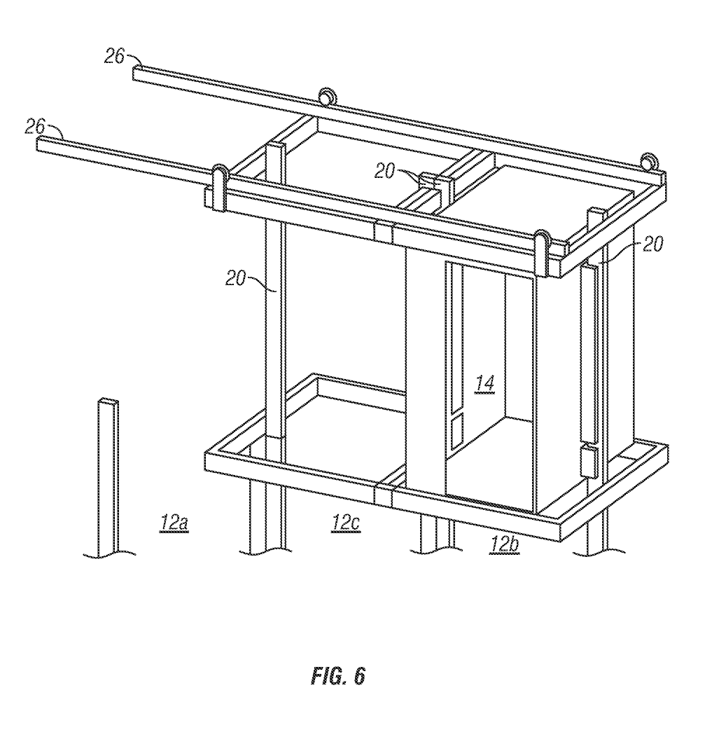

Referring to FIG. 6, in systems 10 with three or more hoistways 12, it may be desirable to utilize transfer cages 18 capable of transferring multiple elevator cars 14 simultaneously. For example, a system 10 with three hoistways 12 may include transfer cages 18 capable of transferring two elevator cars 14 at once. Alternatively, multiple transfer cages 18, each capable of transferring a single elevator car 14 may be located at the same set of transfer rails 26 to reduce transfer times.

The transfer system described herein is both efficient and simple. Because the transfer cage 18 moves substantially horizontally, there is no change in potential energy of the elevator car 14 and the transfer cage 18 throughout the transfer, so the power required to accomplish the transfer is low.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An elevator system comprising:
two or more hoistways;
one or more elevator cars disposed in a first of the two or more hoistways and movable to a second hoistway of the two or more hoistways; and
one or more elevator car transfer mechanisms including:
a transfer cage receptive of an elevator car of the one or more elevator cars; and
one or more transfer rails extending from the first hoistway to the second hoistway, the transfer cage connected to the one or more transfer rails is configured to transfer the elevator car received in the transfer cage by movement of the transfer cage along the one or more transfer rails from the first hoistway to the second hoistway.

2. The elevator system of claim 1, further comprising one or more rollers connecting the transfer cage to the one or more transfer rails.

3. The elevator system of claim 1, wherein the transfer cage includes one or more cage rails substantially alignable with one or more elevator car guides disposed in the first hoistway to guide the one or more elevator cars into the transfer cage.

4. The elevator system of claim 3, further comprising a locking mechanism disposed at the elevator car engagable with the one or more cage rails to hold the one or more elevator cars in the transfer cage.

5. The elevator system of claim 1, wherein the transfer cage is receptive of two or more elevator cars.

6. The elevator system of claim 1, wherein the one or more elevator car transfer mechanisms are disposed in at least one of a top or bottom of the two or more hoistways.

7. The elevator system of claim 1, further comprising one or more intermediate elevator car transfer mechanisms disposed between a top and a bottom of the two or more elevator hoistways.

8. An elevator car transfer apparatus comprising:
a transfer cage receptive of at least one elevator car; and
one or more transfer rails extending from a first elevator system hoistway to a second elevator system hoistway and operably connected to the transfer cage;
wherein the transfer of the at least one elevator car received in the transfer cage is achieved by movement of the transfer cage along the one or more transfer rails from the first elevator system hoistway to the second elevator system hoistway.

9. The transfer apparatus of claim 8, further comprising one or more rollers connecting the transfer cage to the one or more transfer rails.

10. The transfer apparatus of claim 8, wherein the transfer cage includes one or more cage rails substantially alignable with one or more elevator car guides disposed in the first elevator system hoistway to guide the at least one elevator car into the transfer cage.

11. The transfer apparatus of claim 8, wherein the transfer cage is receptive of two or more elevator cars.

12. The transfer apparatus of claim 8, wherein the elevator car transfer mechanism is disposed in at least one of a top or bottom of the first elevator system hoistway or the second elevator hoistway.

13. A method of operating an elevator system comprising:
moving one or more elevator cars substantially vertically in a first direction along a first hoistway;
moving an elevator car of the one or more elevator cars into a transfer cage substantially aligned with the first hoistway; and
translating the elevator car and transfer cage substantially horizontally along a transfer rail extending from the first hoistway to a second hoistway; and
moving the elevator car substantially vertically in a second direction along the second hoistway.

14. The method of claim 13, wherein moving the elevator car into a transfer cage substantially aligned with the first hoistway further comprises:
moving the elevator car along one or more elevator car guides disposed in the first hoistway; and
moving the elevator car from the one or more elevator car guides to one or more transfer rails of the transfer cage, the one or more transfer rails substantially aligned with the one or more elevator car guides.

15. The method of claim 13, further comprising holding the elevator car in the transfer cage via application of a locking mechanism to the one or more transfer rails.

16. The method of claim 13, wherein the first direction is substantially opposite the second direction.

17. An elevator system comprising:
at least three hoistways;
a plurality of elevator cars disposed in the at least three hoistways; and
an elevator car transfer mechanism including:
a transfer cage receptive of an elevator car of the plurality of elevator cars; and
one or more transfer rails extending from a first hoistway of the at least three hoistways to a second hoistway of the at least three hoistways, the transfer cage connected to the one or more transfer rails is configured to transfer an elevator car of the plurality of elevator cars received in the transfer cage by movement of the transfer cage along the one or more transfer rails from the first hoistway to the second hoistway;
wherein a direction of elevator car travel in one or more hoistways of the at least three hoistways is in a first direction and the direction of elevator car travel in one or more hoistways of the at least three hoistways is in a second direction.

18. The elevator system of claim 17, wherein the first direction is substantially opposite the second direction.

19. The elevator system of claim 17, wherein elevator cars in one or more outer hoistways travel in the first direction, and elevator cars in one or more inner hoistways travel in the second direction.

20. The elevator system of claim 17, wherein a direction of travel of elevator cars in the at least three hoistways is reversible.

21. The elevator system of claim 17, wherein the transfer cage includes one or more cage rails substantially alignable with one or more elevator car guides disposed in the at least three hoistways to guide the elevator car into the transfer cage.

22. The elevator system of claim 21, further comprising a locking mechanism disposed at the elevator car engagable with the one or more cage rails to hold the elevator car in the transfer cage.

23. The elevator system of claim 17, wherein the transfer cage is receptive of two or more elevator cars.

24. The elevator system of claim 17, wherein the elevator car transfer mechanism is disposed in at least one of a top or bottom of the at least three hoistways.

25. The elevator system of claim 17, further comprising one or more intermediate elevator car transfer mechanisms disposed between a top and a bottom of the at least three hoistways.

26. An elevator system comprising:
two or more hoistways;
one or more independently-controlled elevator cars disposed in the two or more hoistways; and
two or more lateral transfer mechanisms to move an elevator car of the one or more elevator cars from a first hoistway of the two or more hoistways to a second hoistway of the two or more hoistways;
wherein a direction of travel of elevator cars in a hoistway of the two or more hoistways is uniform among all elevator cars in the hoistway.
